(19) United States
(12) Patent Application Publication
(10) Pub. No.: US 2009/0217885 A1
(43) Pub. Date: Sep. 3, 2009

(54) PET TREAT HOLDER TOY

(76) Inventors: Steven Edward Peter, Blaine, MN (US); Peter John Dukich, Blaine, MN (US)

Correspondence Address: Peter J. Dukich, 2337 132nd Avenue N.E., Blaine, MN, 55449, US

(21) Appl. No.: 12/396,690

(22) Filed: Mar. 3, 2009

Related U.S. Application Data
(60) Provisional application No. 61/067,846, filed on Mar. 3, 2008.

(51) Int. Cl. A01K 29/00

(52) U.S. Cl. 119/709

(57) ABSTRACT

A pet treat holder toy is provided, wherein a pet treat or chew is positively retained by means of mechanical clamping for a pets enjoyment and safety. The design herein is to allow a pet a means to gain all the benefits from a treat or chew while mitigating the occurrence of injury, illness or death to the pet.

### CROSS-REFERENCE TO RELATED APPLICATIONS

This application claims the benefit of Provisional U.S. Application No. 61/067,846 filed Mar. 3, 2008, the entire disclosure of which is incorporated herein by reference.

### FIELD

The present invention relates to a pet treat holder device. More particularly, the present invention relates to pet treat holder devices having recesses and or openings for receiving pet treats that provide positive mechanical pet treat retention.

### BACKGROUND

A wide variety of pet treat holder devices have been developed and available for many years. Consumable and non-consumable toys or treats provide a variety of benefits for a pet and a handler. For a handler, these items encourage social interaction between a handler and a pet. For a pet, these items provide a means for mental stress relief caused by separation anxiety, loneliness and boredom. For physical health, these items provide a pet a means for enhanced dental prophylaxis and masticatory exercise, and relief to pain from teething. Inversely, some consumable and non-consumable toys or treats have adverse effects for a pet.

While observing a pet that is chewing and or ingesting consumable treats, when in the absence of a treat holder, the tendency is for a pet to “hold” a treat between its front paws. Starting at one end of a treat, a pet chews and softens the leading end of a treat to a consistency that will allow a pet to separate a portion of the chew treat to be ingested. Eventually a pet is no longer able to “hold” a treat and, rather than discard the remainder of a treat, a pet will swallow the remainder of a treat, when in some cases, is too large for safe ingestion. For both consumable treats and non-consumable toys the stimulation provided to a pet by the treat or toy may entice a pet to ingest the entire, or large portion of a, treat or toy. Once swallowed by a pet, these oversized objects may cause a pet to choke, or become impacted in the intestinal tract causing gastrointestinal problems, and in some cases lead to fatality to a pet.

The device described herein securely holds a treat in a manner that allows a pet to start chewing a treat at one end, and soften the leading end of a treat to a consistency that will allow a pet to separate a consumable portion of a chew treat that is small enough for ingestion. The devise described herein will allow a pet to “hold” a toy with a treat retained by the device herein allowing a pet to chew a treat completely up to a surface of a pet treat holder. This reduces the possibility of a pet ingesting a piece of a chew treat that is not a desired size for ingestion.

### SUMMARY

Unlike other treat dispensing toy designs that rely solely on friction to delay a pet's ability to dislodge and swallow a treat(s), the device described herein is primarily designed to mechanically secure a pet treat while a pet plays with, chews, or eats a treat. The device described herein will provide the previously mentioned benefits for a pet's health and well being. In addition, this device described herein will add an element of challenge and excitement to a pet's experience while manipulating the device. Specifically for chew treats such as, but not limited to, stick (see FIG. 6A) or flat (see FIG. 6B) rawhide chew treats; this device will mechanically hold a treat firmly and securely. The method of retention described herein will impede a pet's ability to dislodge a treat in whole. A pet will be able to manipulate the device while gnawing at the accessible portion of a treat, chewing and tearing off manageably ingested portions, thereby mitigating the occurrence of undesired ingestion that may result in the previously mention adverse effects.

The disclosure provides a method for mechanically holding a pet treat by means of a positive gripping force between opposing surfaces by, but not limited to, screwing and/or clamping. The physical appearance of this device will have an exterior profile of a geometric shape such as, but not limited to, spherical, cubical, rectangular, triangular, etc. It may contain integral recessed features of geometric shapes such as, but not limited to, a groove with a radii, square, rectangular, triangular, “V” profile, or combination of said profiles. Multiple groove(s) may be utilized, and regardless of profile, the groove(s) may be of varying depth to accommodate a variety of different treat configurations and types. To enhance positive treat retention, additional gripping feature(s) may be added to one, or both of the opposing surfaces or features that come in contact with a treat to either deform and/or penetrate a treat being retained. When a treat is not present, the device may be used as a stand-alone pet toy.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of an exemplary treat holder exhibiting, but not limited to, one coupling feature that join the device elements representative of the present invention.

FIG. 2 is a perspective view of an exemplary treat holder representative of one of the halves of the exemplary treat holder represented in FIG. 1 of the present invention.

FIG. 3 is a perspective view of an exemplary treat holder representative of the corresponding second halve of the exemplary treat holder represented in FIG. 1 of the present invention.

FIG. 4 is a perspective view of an exemplary treat holder represented in FIG. 1 of the present invention, shown retaining an exemplary pet treat represented in FIG. 6A of the present invention retained in an integral feature.

FIG. 5 is a perspective view of an exemplary treat holder exhibiting more than one, but not limited by two, coupling features that join the device elements representative of the present invention, shown retaining an exemplary pet treat represented in FIG. 6C of the present invention retained in an integral feature.

FIG. 6 is a perspective view of three individual exemplary pet chews or treats; A, B, and C.

### DETAILED DESCRIPTION

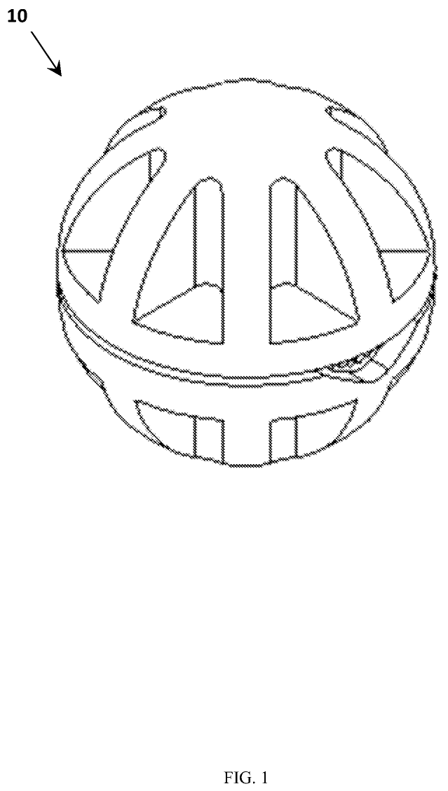

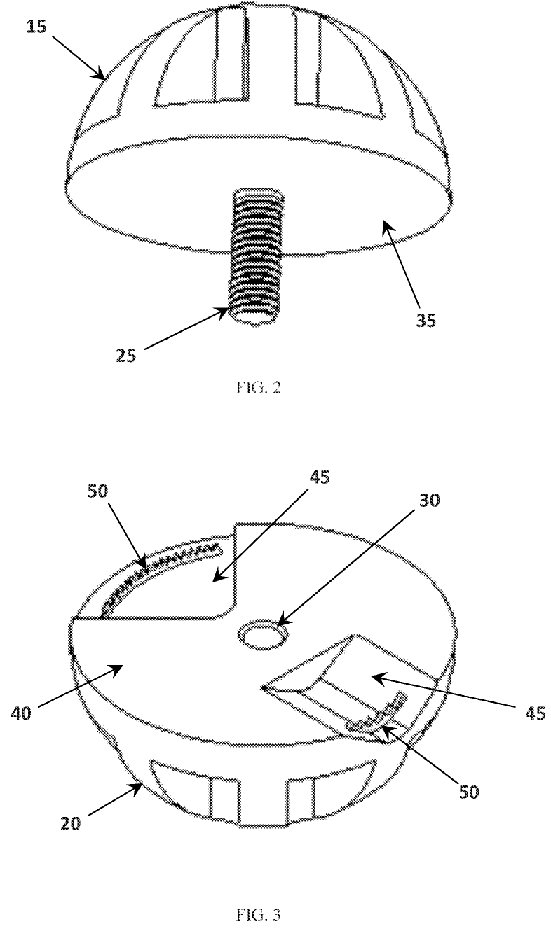

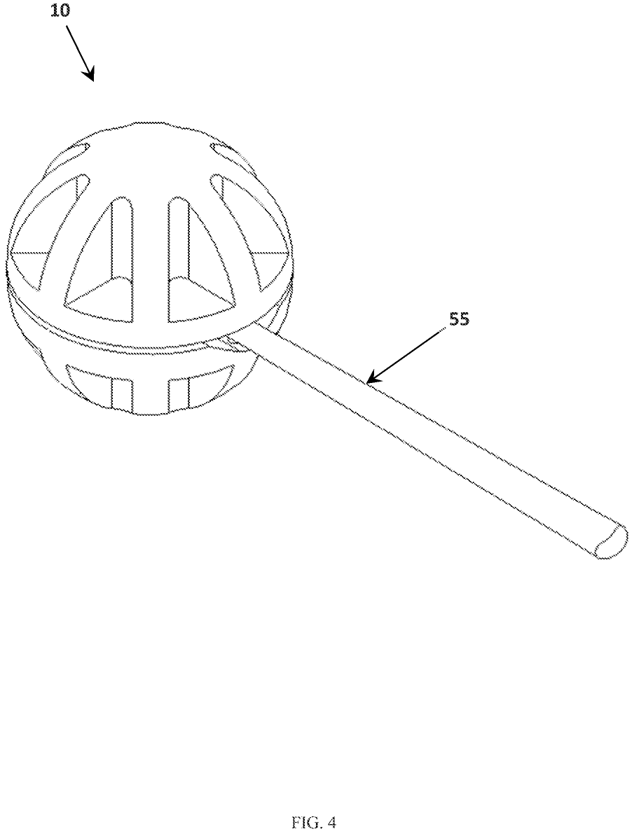

FIG. 1 is a perspective view of an exemplary pet treat holder toy and illustrates a pet treat holder toy 10 in accordance with the present invention. Treat holder 10 includes first hemisphere-shaped member 15 shown in FIG. 2, second hemisphere-shaped member 20 shown in FIG. 3, first coupling feature 25 shown in FIG. 2, illustrated as threaded post exemplary of one potential mechanical feature, and second coupling feature 30 shown in FIG. 3, illustrated as threaded socket exemplary of one potential mechanical feature, such that the two hemispheres fit and join together. First hemisphere-shaped member 15 has a flat surface 35 shown in FIG. 2, that is oriented toward second hemisphere-shaped member 20 that has a corresponding flat surface 40 shown in FIG. 3, comprised of one or possibly more integral recessed feature(s) 45 shown in FIG. 3 of exemplary geometric shapes such as, but not limited to, a groove potentially of varying depth. Integral recessed feature(s) 45 shown in FIG. 3, contains first integral deforming and/or penetrating gripping feature(s) 50 shown in FIG. 3. Second integral deforming and/or penetrating gripping feature(s) may be added to an opposing surface 35 shown in FIG. 2.

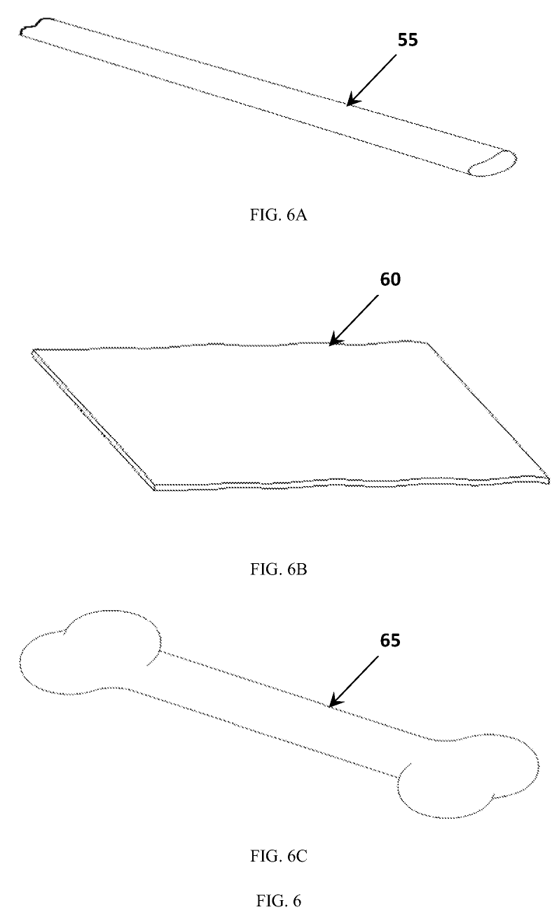

FIG. 4 is a perspective view of an exemplary pet treat holder toy and illustrates a pet treat holder toy 10 shown in FIG. 1 in accordance with the present invention, holding an exemplary pet chew treat 55 shown in FIG. 6A.

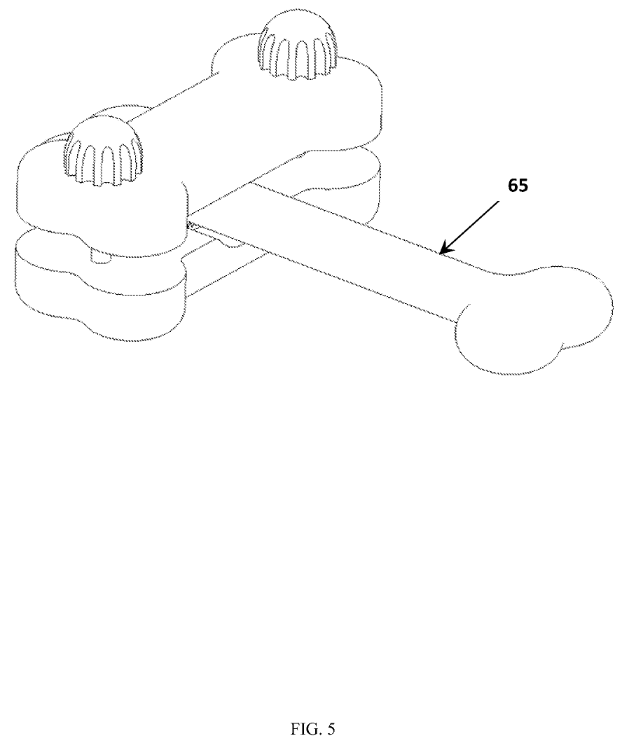

FIG. 5 is shown for reference as a potential configuration of a pet treat holder toy 10 representative of the present invention exhibiting, but not limited to, two coupling features that join the device members, shown retaining an exemplary pet treat 65 represented in FIG. 6C retained in an integral feature.

FIG. 6 illustrates three exemplary shapes of pet products that are either consumable treats or non-consumable chew toys. (A) is a perspective view of a long, narrow, somewhat cylindrical chew treat with some irregularity typically, but not limited to, a rawhide treat that can be either solid or a flat rawhide treat coiled to emulate a cylinder. (B) is a perspective view of a somewhat flat chew treat with some irregularity typically, but not limited to, a rawhide treat. (C) is a perspective view of a “dog bone” shaped chew treat with some irregularity typically, but not limited to, a rawhide treat.

What is claimed is:

1. A pet treat holder toy that provides a means to mechanically retain a pet treat or chew, comprising:
a first member including a first member surface;
a second member including a recess or recesses to accommodate a variety of pet treat or chew profiles;
a feature or features within second member recess or recesses to provide adequate deformation or penetration to a pet treat or chew, first and second members defining a cavity between first and second member that receives and positively retains a pet treat or chew;
a coupling feature in the first member aligned with a coupling feature in the second member such that the first member is variably spaced from the second member to allow adequate retention of a pet treat or chew.

2. A pet treat holder toy of claim 1, wherein a first member surface is adjacent to a second member recess to form a pet treat or chew retaining cavity.

3. A pet treat holder toy of claim 2, wherein a second member including a recess having features to provide adequate deformation or penetration to a pet treat or chew.

4. A pet treat holder toy of claim 2, wherein the coupling feature is adjustable to permit selection of space between the first and second member to compensate for variations in pet treat or chew configuration and thickness.
